(19) United States
(12) Patent Application Publication
(10) Pub. No.: US 2016/0042893 A1
(43) Pub. Date: Feb. 11, 2016

(54) LEVER SWITCH DEVICE OF SADDLE-TYPE VEHICLE AND INSTALLING METHOD THEREOF

(71) Applicant: SUZUKI MOTOR CORPORATION, Shizuoka-Ken (JP)

(72) Inventor: Yuji ONISHI, Shizuoka-Ken (JP)

(21) Appl. No.: 14/812,316

(22) Filed: Jul. 29, 2015

(30) Foreign Application Priority Data
Aug. 6, 2014 (JP) 2014-160341

(51) Int. Cl. H01H 21/22; H01H 11/00

(52) U.S. Cl. CPC H01H 21/22; H01H 11/00; H01H 2221/016; H01H 2205/00

(57) ABSTRACT

A saddle-type vehicle is provided with a lever switch device for an operation lever for operating a clutch lever or a brake lever of the vehicle, and a band-shaped operation switch is arranged in a longitudinal direction of the operation lever at least on an upper surface thereof.

### BACKGROUND OF THE INVENTION

1. Field of the Invention

The present invention relates to a lever switch installing technology for a vehicle, and more particularly, to a lever switch device installed around a handle of a saddle-type vehicle with an operation switch arranged on a surface of an operation lever and also relates to a method of installing such lever switch device for improving safeness and convenience in operation of the vehicle.

2. Description of the Related Art

A handlebar-type steering device is used for a saddle-type vehicle such as a motorcycle or a vehicle for running on a rough terrain (buggy car). On the handlebar-type steering device, switches operated by a thumb of a right hand or a left hand of a driver are provided on a base end side of a handle grip.

Recently, there is a tendency such that the saddle-type vehicle using the handlebar-type steering device is equipped with an increased number of various optional pieces of equipments for enjoying music, radio, navigation and the like, which are installed or mounted on a vehicle body or a helmet. With the increase of such optional equipments, a driver is required to operate or perform many inputting operations. As a measure for such requirement, it is generally made to additionally provide more number of switches on a switch box or like.

In a conventional technology such as disclosed in Patent Document 1 (Japanese Patent Laid-Open No. 2011-194993) and Patent Document 2 (Japanese Patent Laid-Open No. 2013-71718), the additional switches are provided on operation levers (brake lever, clutch lever) other than a handle switch box as a push-button switch or a depressing type switch.

However, in a conventional handlebar-type steering device for a saddle-type vehicle, the increase of the switches in the handle switch box results in difficulty for additionally providing other switches. In addition, since many switches are present in a small range of the handle switch box, a time required for accurately operating a desired switch (feeling check by a fingertip, visual check and the like), becomes longer, which leads to distraction and negligence of safety check by a driver.

Moreover, the handle switch described in Patent Documents 1 and 2 contributes to solve the problem of dense arrangement of the switches on the handle switch box. However, a push-button switch and a depressing type switch provided on the operation lever are push-push type switches, which require mechanical movable structures to be provided for switch components.

Furthermore, an inputting operation of the mechanical movable switch component is one-dimensional operation only in one way, which is hence not suitable for inputting complicated and complex information. For example, the depressing type switch disclosed in Patent Document 2 is a switch for idle control and is constituted to be alternately switched to an idle stop switch and a start switch by simply depressing the switch. Thus, it has been difficult to perform complex switching operations with the handle switches described in the Patent Documents 1 and 2.

### SUMMARY OF THE INVENTION

The present invention was made in view of the above-described circumstances and an object thereof is to provide a lever switch device of a saddle-type vehicle in which a band-shaped operation switch is arranged on an upper surface of the operation lever capable of easily and safely performing a complex switching operation of the operation lever by a hand finger of a driver gripping a handle grip, and also provide a method of installing such lever switch on an operation lever of a vehicle.

The above object can be achieved according to the present invention by providing a lever switch device for a saddle-type vehicle which is provided with an operation lever for operating a clutch lever or a brake lever of the vehicle, wherein the lever switch device includes a band-shaped operation switch arranged in a longitudinal direction of the operation lever at least on an upper surface thereof.

There is also provided a method of installing a lever switch of a saddle-type vehicle in which an operation switch is installed on an operation lever for operating a brake lever or a clutch lever, wherein a band-shaped operation switch is arranged along a longitudinal direction of the operation lever at least on a lever upper surface thereof.

More specifically, the present invention provides a lever switch device for a saddle-type vehicle which is provided with an operation lever for operating a clutch lever or a brake lever of the vehicle, the lever switch device includes a band-shaped operation switch arranged in a longitudinal direction of the operation lever of the vehicle, a pressure sensitive sensor provided for the band-shaped switch, and a controller electrically connected to the pressure sensitive sensor via a wire.

According to the present invention of the structures and characters mentioned above, since the band-shaped operation switch is arranged in the longitudinal direction of the operation lever at least on the upper surface thereof, a complex switching operation can be performed by a ball of a hand finger of a driver while gripping a handle grip, and a lever switch arrangement can provide highly safe and excellent in the lever switching operation.

The nature and further characteristic features will be made clearer from the following descriptions made with reference to the accompanying drawings.

### BRIEF DESCRIPTION OF THE DRAWINGS

In the accompanying drawings:

FIG. 1 is a structural view illustrating a lever switch device for a saddle-type vehicle according to an embodiment of the present invention as viewed from an upper front side of the vehicle;

FIG. 2 is an enlarged partial view of the lever switch device for the saddle-type of FIG. 1 as viewed from an upper right side;

FIG. 3 is an enlarged partial view of the lever switch device for the saddle-type vehicle of FIG. 1 as viewed from an upper left side;

FIG. 4 is a view of an operation lever in the lever switch device for the saddle-type vehicle for explanation of an operating state;

FIG. 5A is a perspective view showing a band-shaped operation switch integrally installed on the operation lever provided in a vicinity of a front side of a handle grip, FIG. 5B is a perspective view illustrating a switch body of the band-shaped operation switch, and FIG. 5C is a perspective view illustrating an internal structure of the band-shaped operation switch;

FIG. 6A is an enlarged view illustrating a part corresponding to a part VIA in FIG. 5B, and FIG. 6B is an enlarged view illustrating a part corresponding to a part VIB in FIG. 5C; and

FIGS. 7A, 7B, and 7C are views respectively illustrating arrangement directions of the band-shaped operation switch installed on the operation lever.

### DESCRIPTION OF THE PREFERRED EMBODIMENT

An embodiment of the present invention will be described hereunder with reference to the accompanying drawings. It is further to be noted that terms “upper”, “lower”, “right”, “left”, “front”, “rear” and the like terms indicating direction are used herein with reference to illustrations of the drawings or a state of a driver on a seat of a vehicle.

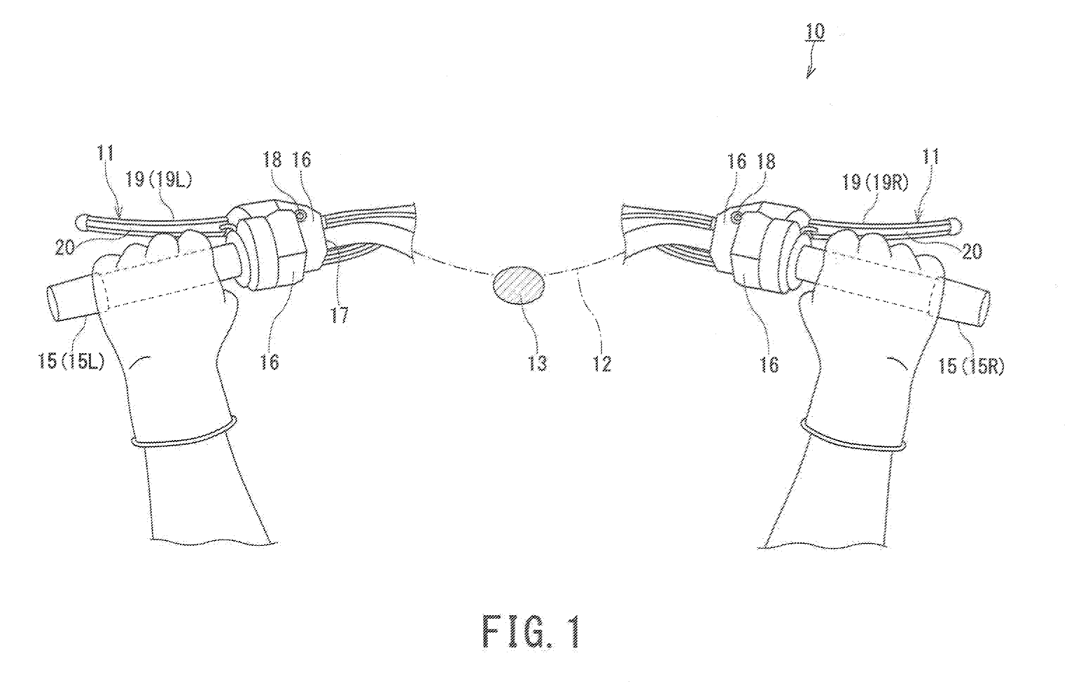

With reference to FIG. 1 illustrating an embodiment of a lever switch device 11 in a saddle-type vehicle 10 such as a motorcycle or a vehicle running on a rough terrain (buggy car), a bar handle 12 for steering a front wheel of a vehicle, not shown, is capable of rotating operation around a steering shaft 13, and a handle grip 15 is provided on both right and left sides in a vehicle width direction, respectively.

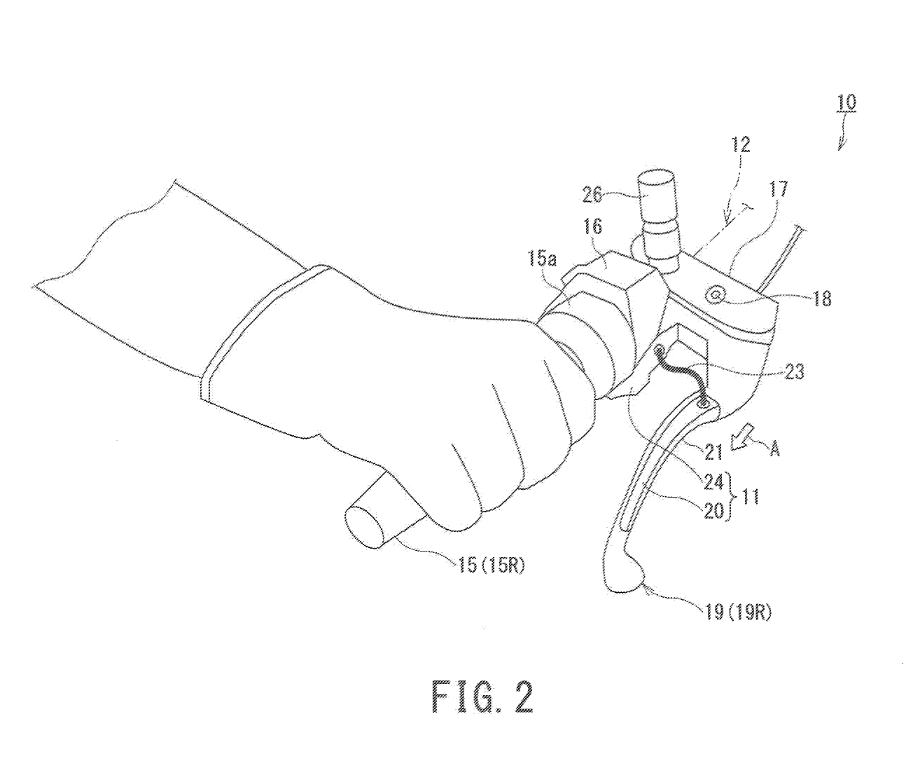

The handle grip 15 includes a right side throttle grip 15R and a left side L-side grip 15L. A mounting bracket 17 is provided in a vicinity of an inner flange portion (i.e., end portion) of each of the right and left handle grips 15 through a handle switch box 16, and right and left operation levers 19 are mounted on the mounting brackets 17 to be rotatable around a support shaft 18. A side-mirror stand 26 (FIG. 2) is provided on the mounting bracket 17.

The operation lever 19 extends in a vicinity of a front side of the handle grip 15 and in the vehicle width direction substantially along a longitudinal direction of the handle grip 15, and a lever end is provided on a lever outer end portion. The operation lever 19 is bent smoothly in a direction with an outer side thereof in the vehicle width direction gradually separating away from the handle grip 15. The operation lever 19 on the right side of the vehicle body is a brake lever 19R for operating a brake of the front wheel, and the operation lever 19 on the left side of the vehicle body is a clutch lever 19L for operating a clutch.

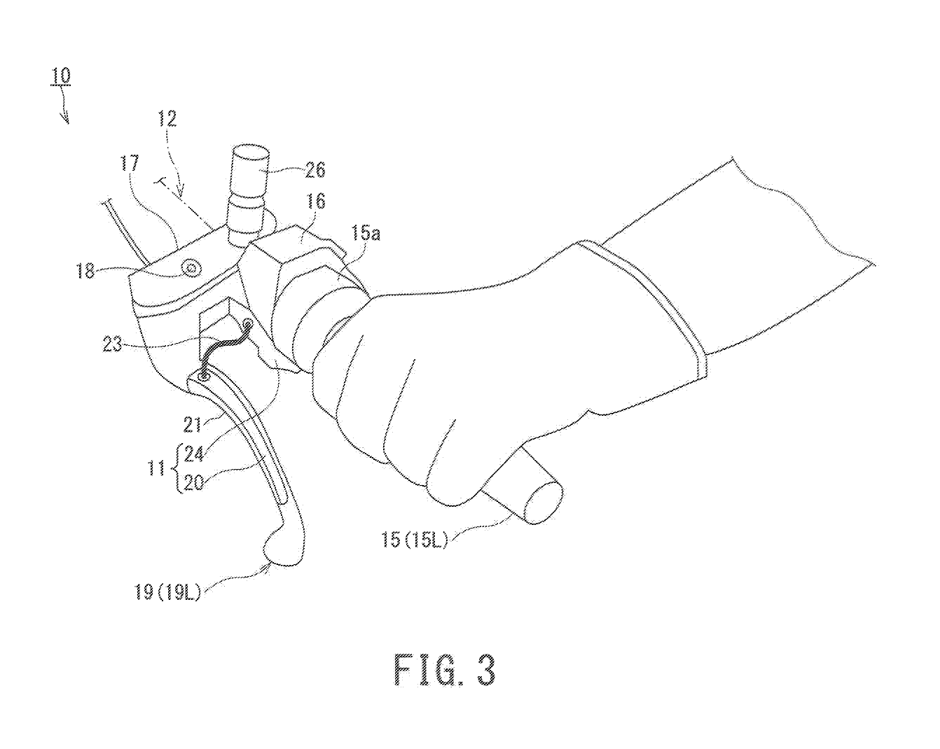

The right and left operation levers 19 have substantially symmetrical structures in the vicinity of the front side of the handle grip 15. The operation lever 19 on the right side of the vehicle body is, as illustrated in FIG. 2, the brake lever 19R, and the operation lever 19 on the left side of the vehicle body is the clutch lever 19L as illustrated in FIG. 3. The right and left operation levers 19 takes an operation state when being rotated around the support shaft 18 and drawn closer to the handle grip 15 (throttle grip 15R, left-side grip 15L), while these grips take a released state when the operation lever 19 is released and returned by an action of a spring.

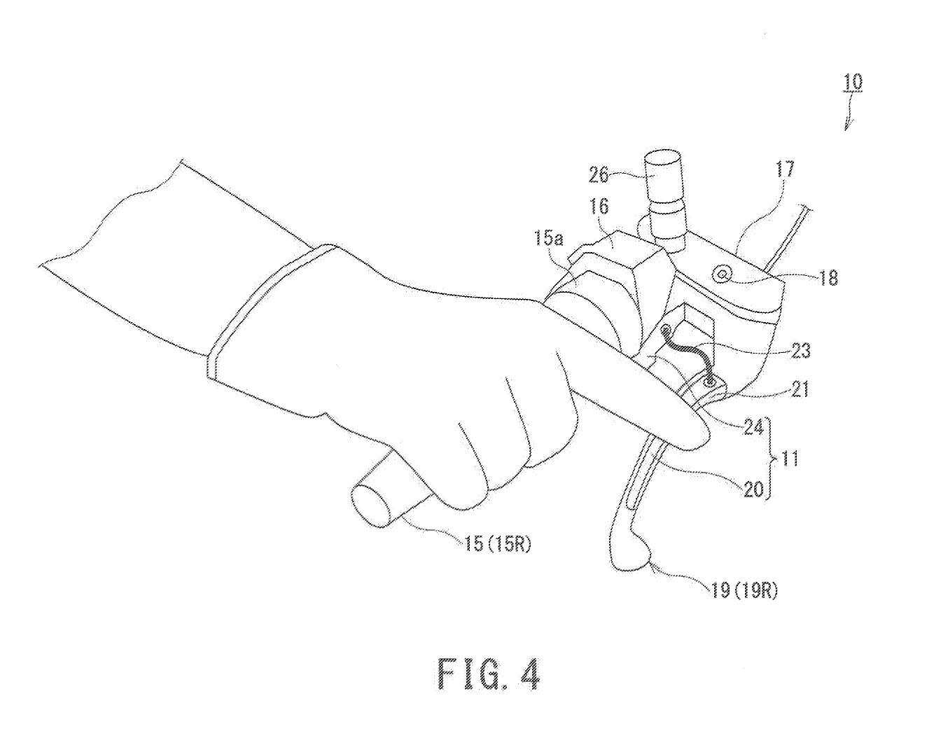

More specifically, as illustrated in FIG. 4, in a state in which the handle grip 15 (throttle grip 15R) is gripped by a driver, while the right-side operation lever 19 (brake lever 19R) is hooked by a finger and drawn closer to the handle grip 15 (throttle grip 15R) side, the right-side operation lever 19 (brake lever 19R) enters an operation state. The brake lever 19R operates a drum brake lever on the front wheel, not shown, in the operation state so as to brake the front wheel. On the other hand, by leaving the finger of the hand from the brake lever 19R, the brake lever 19R is returned and released by a restoring action of a spring.

When the left-side operation lever 19 (clutch lever 19L) is operated similarly to the right-side operation lever 19 (brake lever 19R), by drawing the clutch lever 19L closer to the handle grip 15 (left-side grip 15L) side, it enters the operation state, and on the other hand, by leaving the finger of the hand from the clutch lever 19L, the clutch lever 19L is returned by the restoring action of the spring and enters the released state.

A band-shaped operation switch 20 is provided integrally on or integrated with the right and left operation levers 19 (brake lever 19R, clutch lever 19L). The operation switch 20 is disposed so as to extend in a longitudinal direction at least on an upper surface of the operation lever 19 from a lever base end side to the lever outer end side in the vehicle width direction (lever outer end side) as indicated by reference character A (FIG. 2).

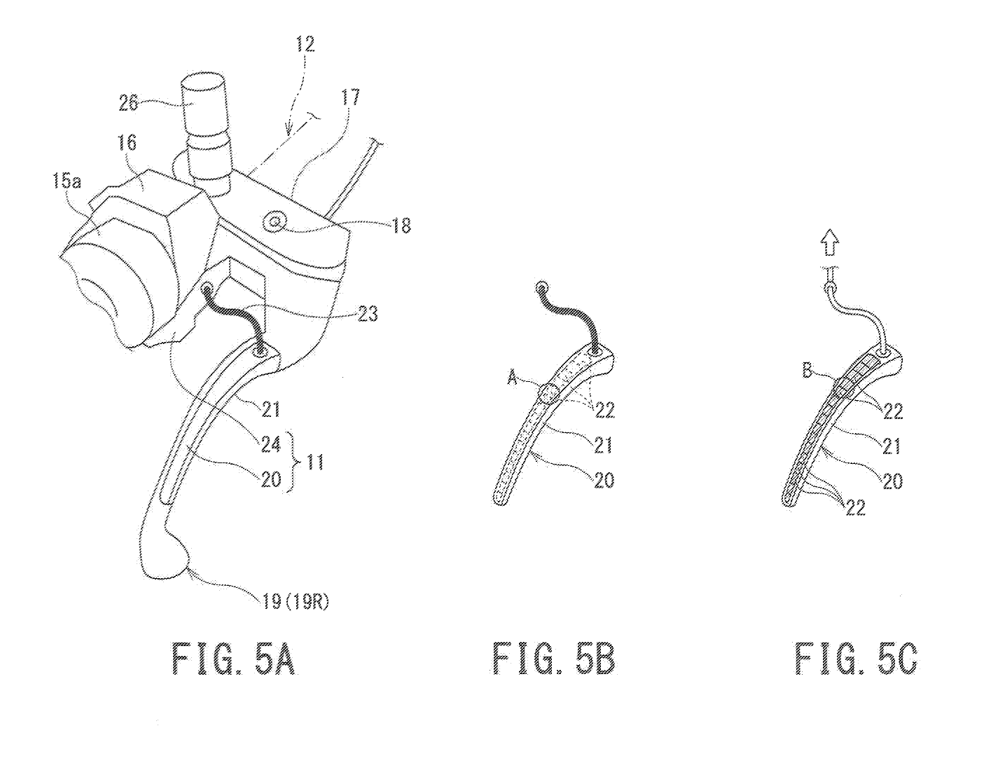

The lever base portion of the operation lever 19 is provided in front of a grip inner flange portion 15a of the handle grip 15 in a vehicle running direction. The band-shaped operation switch 20 may be disposed so as to wrap the operation lever 19 from the lever upper surface toward the lever front surface. The band-shaped operation switch 20 arranged at least on the upper surface of the operation lever 19 is constituted as illustrated in FIGS. 5A, 5B and 5C.

The band-shaped operation switch 20 is an elongated flexible sensor in shape of sheet constituted as a sheet sensor having a switch body 21 on which pressure-sensitive sensors 22 formed in plural or integrally by being juxtaposed in a row in the longitudinal direction or by disposing a plurality of pressure-sensitive sensors 22 juxtaposed in plural rows (i.e., five rows in FIG. 5C) in the longitudinal direction of the operation switch 20. Accordingly, the band-shaped operation switch 20 may be made entirely as a sheet-state and thin band-shaped pressure-sensitive sensor (hereinafter referred to as a band switch 20 for the sake of convenience).

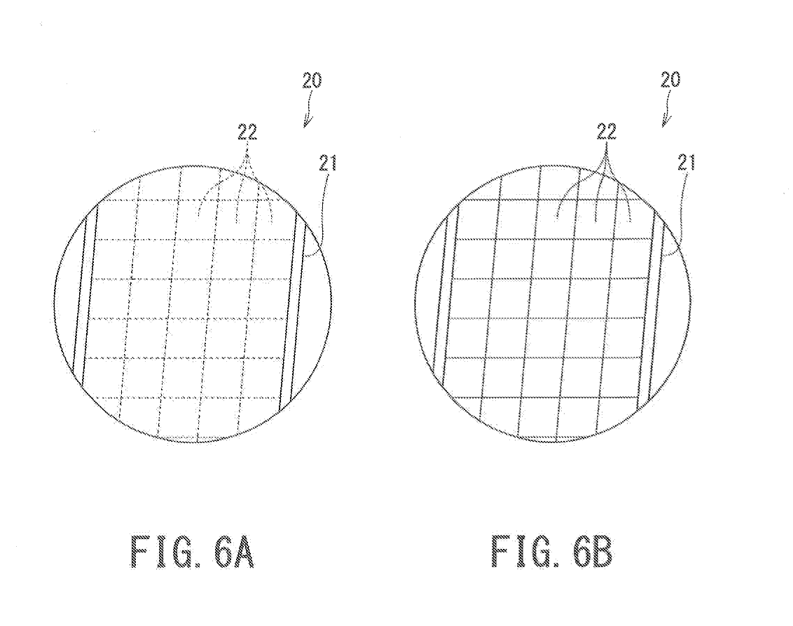

FIGS. 6A and 6B are examples in which elements of the pressure-sensitive sensors 22 takes planar arrangement in a grid shape or in a checkerboard shape and constituted by circuit elements each of which converts magnitude of or change in a force to an electromagnetic amount for detection.

The pressure-sensitive sensor 22 of the band switch 20 is electrically connected to a controller 24 via a wire 23 such as a lead wire and a signal line or wirelessly connected such as Bluetooth (registered trademark) or the like. The controller 24 is arranged at an appropriate position of the vehicle body of the saddle-type vehicle 10, that is, a portion below a seat, not shown, of the saddle-type vehicle 10 and hardly affected by a temperature. The controller 24 may be provided on a lower part of the handle switch box 16.

The band switch 20 is configured to convert a switch input to an electric signal, which is then transmitted to the controller 24. The controller 24 analyzes signal contents (electricity amount) of a detected electric signal switch-inputted from the band switch 20. The controller 24 discriminates whether the switch input is an intentional switch input for a switching operation of the band switch 20 or it is an unintentional input for a clutch operation or a brake operation of the operation lever 19 on the basis of the signal contents obtained by analyzing the lever operation of the operation lever 19. In the case of the intentional switch input to the band switch 20, the controller 24 outputs an operation signal to a corresponding operation device (not shown).

### [Method of Installing Band-Shaped Operation Switch (Band Switch) 20]

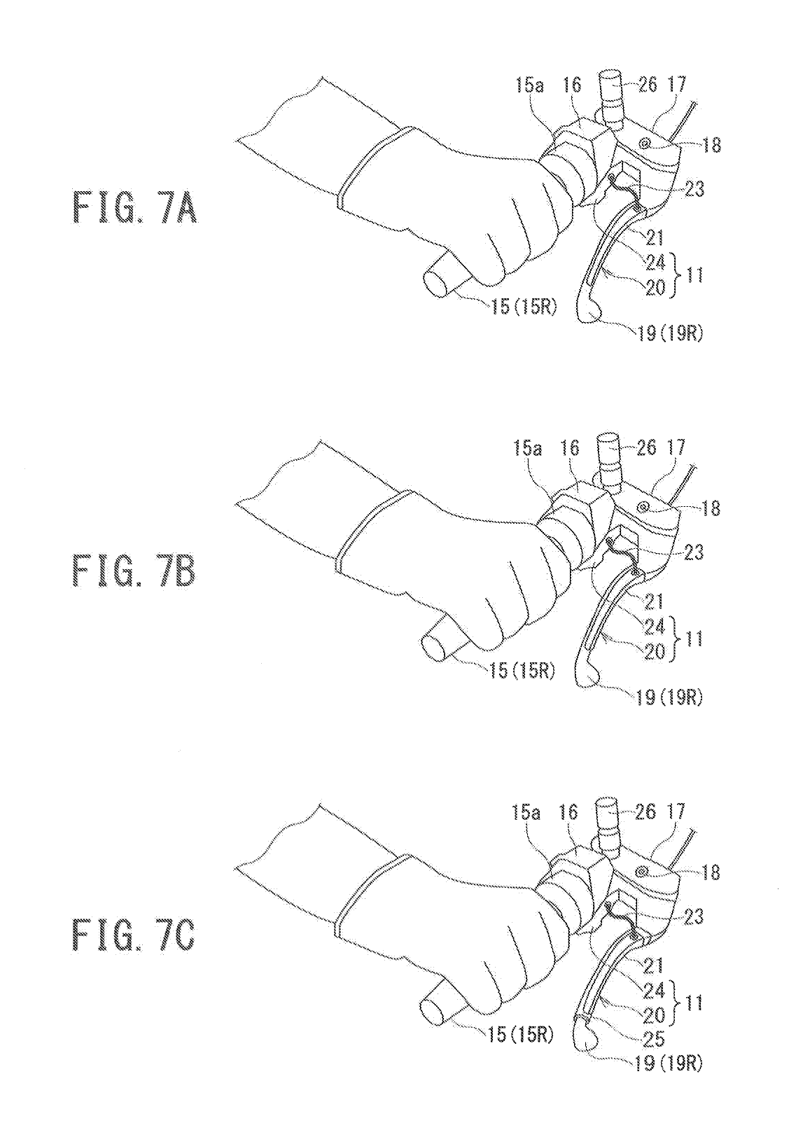

As illustrated in FIGS. 7A, 7B, and 7C, the band switch, which is the band-shaped operation switch 20, is arranged at least on the upper surface of the operation lever 19, and the following three types of the band switch arranging methods may be provided. The operation switch 20 may take planar arrangement from the lever upper surface in the operation lever to the lever front surface along the longitudinal direction thereof.

In a first arrangement method shown in FIG. 7A, the operation lever 19 and the band switch 20 are integrally formed, in which the operation lever 19 is formed with an installation recess extending in the lever longitudinal direction at least on the lever upper surface of the lever body, and the band-shaped operation switch 20 is incorporated in the installation recess so as to provide an integral built-in structure.

In a second arrangement method shown in FIG. 7B, the separate sheet-shaped band switch 20 is bonded to the existing operation lever 19 so that the band switch 20 is installed at least on the lever upper surface of the operation lever 19. The band switch 20 to be installed onto the operation lever 19 may be integrated by means of bonding, or the band switch 20 may be detachably installed to the existing operation lever 19.

In a third arrangement method shown in FIG. 7C, a flexible tube 25 to which the band switch 20 is bonded is provided so as to cover the existing operation lever 19 for attachment. In this method, the flexible tube 25 to which the band switch 20 has been bonded is inserted above to the existing operation lever 19 to be covered thereby so as to be located at least on the upper surface of the operation lever 19.

In the forgoing description, FIGS. 7A, 7B, and 7C all illustrate examples in which the band switch 20 is installed at least on the upper surface of the operation lever 19 (brake lever 19R) in the vicinity of the front side of the right-side handle grip 15 (throttle grip 15R), but the band switch 20 is also installed on the operation lever 19 (clutch lever 19L) of the left-side handle grip 15 (left-side grip 15L) in the manner similar to those mentioned above with reference to the right-side handle grip 15 (15R).

Hereunder, an operation or function of the lever switch device 11 of the present embodiment described above will be explained.

In the described embodiment, the lever switch device 11 is provided on the operation lever 19 of the bar-handle type steering device for the saddle-type vehicle 10. In such lever switch device 11 of the present embodiment, the band switch 20 is newly installed in the longitudinal direction from the lever base end portion to the lever side end in the vehicle width direction, and the band switch is disposed at least on the lever upper surface of each of the right and left operation levers 19 besides the switches, not shown, operated by a thumb on a grip base end side of the handle grip 15.

In the band switch 20, a plurality of the sheet-shaped thin pressure-sensitive sensors 22 are disposed in the longitudinal direction thereof. The band switch 20 has some length in the longitudinal direction of the operation lever 19 and a width in a direction orthogonal to the longitudinal direction of the operation lever 19 and thus, the driver can perform the switching operation of the band switch 20 by extending his finger while driving the vehicle and operate the band switch 20 in a simple and smooth inputting operation.

The lever switch device 11 constituted by the band switch 20 and a signal analysis controller 24 is capable of performing complex and diversified inputting operations by operating the band switch 20. For example, by adopting planar arrangement of the band switches 20 in the grid shape at least on the lever upper surface of the operation lever 19, the band switch 20 is capable of performing inputting operation not only by a simple tapping (depressing) operation but also by a swiping operation by sliding a finger laterally or longitudinally to perform a point-and-line (or plane) switching operation.

The switching operation of the band switch 20 can be performed in parallel with the clutch operation or the brake operation when the lever operation is needed. Particularly, at an occasion of sudden braking, an idle running distance can be drastically reduced only by gripping the operation lever 19 (brake lever 19R), which can largely contribute to safety.

In the lever switch device 11 of the saddle-type vehicle 10, since the band switch 20 and the controller 24 provided on the operation lever 19 (brake lever 19R, clutch lever 19L) are used, complicated and complex inputs due to, for example, different numbers of tapping times on the band switch 20 or due to different directions in swiping operation of the finger (i.e., laterally or longitudinally), can be performed by the simple switching operation.

For the pressure-sensitive sensor 22 of the band switch 20, by taking the planar arrangement of the sensor elements in the grid shape, the switch inputting operations can be made not only by the swiping operation in the lateral direction but also by the swiping operation in the longitudinal direction, thus advantageously increasing possibility of combinations of the switching operations.

[Example of Band Switch]

Specific examples of performing the operation input of the band switches 20 provided for the right and left operation levers 19 (brake lever 19R, clutch lever 19L) will be described hereunder.

In one example of the switching operation input, the band switch 20 of the right-side operation lever 19 (brake lever 19R) is given a vehicle running-mode switching function, and the band switch 20 of the left-side operation lever 19 (clutch lever 19L) is also given a switching function of a music mode or a radio mode.

(1) Operation Example of Right-Side Band Switch

The band switch 20 installed on the right-side operation lever 19 (brake lever 19R) switches the running mode of the vehicle by the following switching operations:

| Switching | Number of Operation Times | |
|---|---|---|
| Operation | or Operation Direction | Contents of Operation |
| Tapping | One Time | Start Running Mode |
| | | Switching |
| Swiping | Left-side to Right-side | Transfer to Power Mode |
| | | (Power-up Mode, High-speed |
| | | Running Mode, etc.) |
| Swiping | Right-side to Left-side | Transfer to Wet. Mode (Both |
| | | Running Mode, etc.) |
| Swiping | Laterally | Transfer to Standard Mode |
| Tapping | Two Times | Finish Running Mode |
| | | Switching |

(2) Operation Example of Left-Side Band Switch

The band switch 20 installed on the left-side operation lever 19 (throttle lever 19L) switches the music mode or the radio mode by the following switching operation:

| Switching | | |
|---|---|---|
| Operation | Number of Operation Times | Contents of Operation |
| Swiping | Left-side to Right-side | Volume-up of Income |
| Swiping | Right-side to Left-side | Volume-down of Income |
| Swiping | Laterally | Sound Cancelling |
| Tapping | One Time | Start Music Mode |
| Swiping | Back-side to Front-side | Postponement of Song |
| Swiping | Front-side to Back-side | Return of Song |
| Tapping | Two Times | Start Radio Mode |
| Swiping | Back-side to Front-side | Postponement of Preset |
| | | Tuning |
| Swiping | Front-side to Back-side | Return of Present Tuning |

It is further to be noted that various operation modes for the operation examples of the tapping and swiping operations of the right-side or left-side band switches 20 of the operation lever 19 may be considered other than the above examples. For example, the swiping (sliding) of the right-side band switch 20 can cause a blinker to turn to the left to flash by the swiping (sliding) operation from right to left, or on the contrary, can cause a blinker to turn to the right to flash by the swiping (sliding) from left to right. Moreover, in a case of being combined with a navigation device or the like, scrolling of a map in a vertical or a horizontal direction can be made so as to correspond to the lateral or longitudinal swiping operation.

According to the embodiment mentioned above, the following advantageous effects will be attainable.

That is, the lever switch device 11 of the saddle-type vehicle 10 is capable of performing the complex switching operations and complicated information inputting operations by the simple operations of a finger of a hand of a driver. More specifically, by the point-tapping and line (or plane)-swiping operations in a state of the driver gripping the handle grip 15 only with a simple constitution in which the band-shaped operation switch (band switch) 20 is arranged along the lever longitudinal direction at least on the lever upper surface of the operation lever 19 located on the right and left handle grips 15 in the vicinity of the front side of the vehicle.

Moreover, additional installation of the lever switch device 11 is easy and inexpensive without requiring a change in the layout of the operation lever 19 in a periphery of the handle grip 15 of the general saddle-type vehicle 10.

The switching operation of the band switch 20 of the operation lever 19 located in the vicinity of the front side of the handle grip 15 is basically performed by a forefinger, and the switching operation can be performed in a complex manner with the point (tapping) operation and the line (swiping) operation. In addition, switching operation range can be within the point-tapping and line-swiping operation area.

Moreover, since the band switches 20 of the operation lever 19 include a plurality of pressure-sensitive sensors aligned in the longitudinal direction thereof, the driver can perform a plurality of switching operations by the ball of his (or her) finger only by extending the finger to the sensor while driving.

Furthermore, the installation of the band switch 20 on the operation lever 19 includes various methods of installing or mounting the band switch 20 such as a method of installing the band switch 20 and the lever body by means of integral molding, a method of bonding the band switch on the existing operation lever, and a method of inserting a tube to which the band switch is bonded into the existing operation lever so as to cover the tube.

### [Another Embodiment]

In the embodiment according to the present invention described above, although the example, in which the band switch 20 is installed on each of the right and left operation levers 19 provided in the vicinity of the front side of the handle grip 15, is explained, there may be provided an installation technology as another embodiment in which, in addition to the provision of the band switches 20 on both the right and left operation levers 19, a rotation ring is additionally provided on the left-side handle grip 15 (15L) and the operation switch provided with a pressure-sensitive sensor is mounted on the rotation ring.

Furthermore, in a state in which the operation switch is provided with a plurality of the pressure-sensitive sensors laid over the entire handle grip 15, there may be additionally provided a handle switch structure having a function of assigning the operation contents of the switch input in each time when each finger of the hand holds with strong force from a state (gripping state) in which the handle grip 15 is gripped ordinal force.

Further, in the embodiments of the present invention described above, although a motorcycle and a vehicle running on a rough terrain are exemplified as saddle-type vehicles, the present invention may be applicable to senior vehicles, snowmobiles, water bikes, construction machines, other transportation equipment and the like.

It is further to be noted that the present invention is not limited to the described embodiments and many other changes, modifications, alternations, and other equivalents may be made within the sprits or scopes of the present invention recited in the appended claims.

What is claimed is:

1. A lever switch device for a saddle-type vehicle which is provided with an operation lever for operating a clutch lever or a brake lever of the vehicle, wherein the lever switch device includes a band-shaped operation switch arranged in a longitudinal direction of the operation lever at least on an upper surface thereof.

2. The lever switch device for a saddle-type vehicle according to claim 1, wherein the band-shaped operation switch is arranged in the longitudinal direction of the operation lever extending from a lever base portion of the operation lever located in a vicinity of a front side of an inner flange portion of a handle grip toward a lever outer end side in a vehicle width direction.

3. The lever switch device for a saddle-type vehicle according to claim 1, wherein the band-shaped operation switch is provided with a plurality of pressure-sensitive sensors formed integrally to or integrated with a switch body in a manner juxtaposed in the lever longitudinal direction.

4. The lever switch device for a saddle-type vehicle according to claim 1, wherein the band-shaped operation switch is provided with a plurality of pressure-sensitive sensors arranged by being juxtaposed in plural rows in the lever longitudinal direction at least on the upper surface of the operation lever, and the pressure-sensitive sensors are arranged in a grid shape in plane on the upper surface of the operation lever.

5. The lever switch device for a saddle-type vehicle according to claim 1, wherein the band-shaped operation switch is installed at least on an upper surface of the operation lever located in a vicinity of a front side of a vehicle in a handle grip to be operated with a finger of a hand of a driver gripping the handle grip.

6. The lever switch device for a saddle-type vehicle according to claim 1, wherein a controller is further provided and wherein the band-shaped operation switch is configured to convert a switching operation to an electric signal which is then output to the controller, and the controller is configured to analyze a received the electric signal and determine, based on an electric signal amount, whether the lever operation is made either by a brake lever or a clutch lever, or a switching operation by a band-shaped operation switch, and then to output an operation instruction according to the determination thereof.

7. The lever switch device for a saddle-type vehicle according to claim 1, wherein the band-shaped operation switch is provide with a plurality of switch pieces configured to be operated, in combination, by a tapping operation, which is performed by depressing a switch surface, and a swiping operation, which is performed by sliding on the switch surface.

8. A method of installing a lever switch of a saddle-type vehicle in which an operation switch is installed on an operation lever for operating a brake lever or a clutch lever, wherein a band-shaped operation switch is arranged along a longitudinal direction of the operation lever at least on a lever upper surface thereof.

9. The lever switch installing method of a saddle-type vehicle according to claim 8, wherein an installation recess is formed at least on an upper surface of the operation lever extending in a lever longitudinal direction, and a band-shaped operation switch is integrally disposed in the installation recess in the lever longitudinal direction.

10. The lever switch installing method of a saddle-type vehicle according to claim 8, wherein a band-shaped operation switch is installed in the operation lever along the longitudinal direction thereof at least on the lever upper surface.

11. The lever switch installing method of a saddle-type vehicle according to claim 8, wherein a tube to cover the operation lever is prepared, the tube is bonded to the band-shaped operation switch, and the band-shaped operation switch is disposed in the longitudinal direction of the operation lever at least on the upper surface thereof.

12. The lever switch installing method of a saddle-type vehicle according to claim 8, wherein a plurality of pressure-sensitive sensors formed integrally or separately are arranged by being juxtaposed in the longitudinal direction of the operation lever, and the pressure-sensitive sensors are incorporated in a switch body or disposed on a back surface thereof.

13. A lever switch device for a saddle-type vehicle which is provided with an operation lever for operating a clutch lever or a brake lever of the vehicle comprising:
a band-shaped operation switch arranged in a longitudinal direction of the operation lever of the vehicle;
a pressure sensitive sensor provided for the band-shaped switch; and
a controller electrically connected to the pressure sensitive sensor via a wire.
